(19) United States
(12) Patent Application Publication
(10) Pub. No.: US 2005/0029777 A1
(43) Pub. Date: Feb. 10, 2005

(54) Coating material for covering an airbag, and a method of producing the coating material

(76) Inventor: Ludwig Fleiner, Reutlingen (DE)

Correspondence Address: MICHAEL J. STRIKER, 103 EAST NECK ROAD, HUNTINGTON, NY, 11743, US

(21) Appl. No.: 10/910,656

(22) Filed: Aug. 3, 2004

(30) Foreign Application Priority Data
Aug. 5, 2003 (DE) 103 35 712.2

(51) Int. Cl. B05D 3/02

(52) U.S. Cl. 280/728.1; 427/299; 427/372.2; 427/402; 428/473

(57) ABSTRACT

A coating material for covering an airbag in an inner space of a motor vehicle has an area portion adapted to face an airbag, the area portion being formed as a treated portion with a treatment selected from the group consisting of a chemical treatment, a thermal treatment and both, with use of a fluid selected from the group consisting of an alkaline solution, a caustic soda, an acid, a hydrochloric acid, and a combination thereof.

### BACKGROUND OF THE INVENTION

The present invention relates to a coating material for covering an airbag in an inner space of a motor vehicle, and a method of producing the coating material.

In almost all motor vehicles airbags are integrated in dashboards at the co-driver side. Further airbags can be provided in a steering wheel, in side walls, or in a roof region of a motor vehicle. In order to avoid influencing the operation of an airbag, the covering of a dashboard or a side covering in many cases is dispensed with at the side of the airbag, and the individual airbags have a special covering.

In the automobile industry there is however a desire to make the airbag as invisible as possible or cover it in a vehicle. For this reason, coating materials are proposed for the dashboard, which also cover the airbag box cover and in the region of the boundary of the airbag box cover are scratched from the rear side to define in this location a breaking point when an airbag are unfolds after an activation.

Since the coatings are frequently produced from leather, which has no homogenous material properties and in its three-dimensional fiber structure possess a very high strength, it has been determined that the scratching of the covering material must be very intense to guarantee unfolding of the airbag when needed. Then however the coating material in the region of the material weakening is so thin, that the material weakening line can be also seen on the outer side of the coating material because of the great temperature and moisture differences acting in a motor vehicle. Therefore in this case it is not possible to arrange an airbag in the inner space of a motor vehicle so that it is invisible.

European patent document EP 1 213 193 A1 discloses a coating for a dashboard, a steering wheel and the like with an integrated airbag which in the region of the boundary of a coating is perforated. With this mechanical treatment of the coating, a required breakage point is provided in a very discrete form, which however under the action of temperature in the inner space of a motor vehicle can expand. Therefore, the perforation is very much visible.

### SUMMARY OF THE INVENTION

Accordingly, it is an object of the present invention to provide a coating material for covering of an airbag which avoids disadvantages of the prior art, and a method of producing the material.

More particularly, it is an object of the present invention to provide a coating material for covering an airbag, which on the one hand can permanently cover an airbag without providing special structural features on the visible side of covering material and without leaving imprint, and on the other hand which maintains the functions of an airbag when needed in an unlimited manner.

In keeping with these objects and with others which will become apparent hereinafter, one feature of the present invention resides, briefly stated, in a coating material for covering an airbag in an inner space of a motor vehicle, comprising an area portion adapted to face an airbag, said area portion being formed as a treated portion with a treatment selected from the group consisting of a chemical treatment, a thermal treatment and both, with use of a fluid selected from the group consisting of an alkaline solution, a caustic soda, an acid, a hydrochloric acid, and a combination thereof.

In accordance with another feature of the present invention, a method of producing a coating material is provided, which includes the steps of forming an area portion adapted to face an airbag as a treated portion with a treatment selected from the group consisting of a chemical treatment, a thermal treatment and both, with use of a fluid selected from the group consisting of an alkaline solution, a caustic soda, an acid, a hydrochloric acid, and a combination thereof.

When the coating material is formed and a method is performed in accordance with the present invention, the disadvantages of the prior art are eliminated and the above-mentioned advantages are provided.

The novel features which are considered as characteristic for the present invention are set forth in particular in the appended claims. The invention itself, however, both as to its construction and its method of operation, together with additional objects and advantages thereof.

### DESCRIPTION OF THE PREFERRED EMBODIMENTS

In accordance with the present invention a surface portion of a coating material of an airbag at a side which is opposite to the airbag is chemically and/or thermally treated.

The inventive solution has the significant advantage that different materials in structure, thickness, composition, etc. can be treated deliberately at locations, at which a breakage location is needed. The strength of a material can be reduced to a desired degree by the inventive chemical and/or thermal treatment punctually and/or linearly, without recognizing such a material change on the visible side of the inventive treated coating material.

The visible side of the coating material over the whole area remains unchanged, when on the rear side punctual, linear or area breakage points are formed by the chemical and/or thermal treatment, where the coating material must be deliberately torn under an increased load.

The coating materials can include natural leather, synthetic leather, covering materials of fibers of any type or synthetic plastic foils. Depending on the material, individual treatment is provided with respect to the timely use of the concentration, the quantities, the temperature, etc. determined for the corresponding coating material to be treated to provide the desired locally determined breakage points in the desired structuring.

When as a fluid for leather caustic soda is used, the strength of the leather can be reduced at the locations. When the caustic soda comes in contact with leather. Depending on the leather quality, leather structure the treatment time is determined for the corresponding surface portion, to provide the desired material weakening at the predetermined locations.

Preferably, the chemical and/or thermal treatment of the leather is performed when the leather is split to a uniform defined layer thickness. Then the chemical and/or thermal treatment is performed, and during this chemical and/or thermal treatment a material loss must occur on the treated locations, so that after the material treatment the treated leather is again split in a form, such that the material loss due to chemical and/or thermal treatment is compensated.

With the treatment for example by hydrochloric acid, naturally on the rear side of a leather to be treated the leather after the treatment with caustic soda can be again swollen, so that a uniform layer density is produced over the whole area of the coating material (treated and non-treated areas).

It is important with the inventive chemical and/or thermal treatment of a coating material that the layer thickness of the leather or another coating material after treatment on the side facing an airbag is also flat, so that on the visible side of the treated coating material no breakage points can be recognized.

When due to a chemical and/or thermal treatment of area portions a material loss takes place on the treated points, this material loss can be filled for example by a hot adhesive, for example to be compensated. After the material application, a new splitting of the treated leather is performed, to produce a uniform plane rear side which can cover an airbag without raised portions or depressed portions.

In accordance with a further embodiment of the present invention, the coating material of leather is produced with a chemical and/or thermal treatment before or after the finishing. This has the advantage that different material structures of these natural product can be taken into account. Different material properties can be taken into consideration to design the desired breakage locations on a leather blank, which are invisible from the visible side.

Preferably, the leather has a material thickness from 0.6 mm to 2.8 mm. With these material thicknesses during the inventive chemical and/or thermal treatment the breakage points are produced on the rear side of the leather, while on the front side, or in other words on the visible side, they are not recognizable.

The leather at the side facing the airbag can be provided with a cover layer composed of a foam material, synthetic plastic or a varnish, which covers the treated area portion. This has the advantage that the treated leather can be affected with respect to its material properties subsequently. The strength all together can be changed, the surface hardness of the leather and its yielding to pressure is changeable, and the treated area portion can be protected by a varnish layer.

Furthermore, in accordance with another embodiment of the present invention, the leather at the side facing the airbag can be provided with a cover sheet of a varnish or the like, which leaves out the treated area portion, so that with such a design of the treated leather an increase sensibility of the treated leather in the regions of the breakage points can be achieved.

The untreated area portion is stabilized with the varnish layer point, i.e. the strength in these regions is increased with the varnish layer. To the contrary, in the regions of the treated area portion with the inventive chemical and/or thermal treatment, the material weakening is reduced without changes. This guarantees that when a covering is provided with the coating material treatment in accordance with the present invention, an objectionable unfolding of an airbag is obtained.

It will be understood that each of the elements described above, or two or more together, may also find a useful application in other types of constructions and method differing from the types described above.

While the invention has been illustrated and described as embodied in a coating material for covering an airbag, and a method of producing the coating material, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A coating material for covering an airbag in an inner space of a motor vehicle, comprising an area portion adapted to face an airbag, said area portion being formed as a treated portion with a treatment selected from the group consisting of a chemical treatment, a thermal treatment and both, with use of a fluid selected from the group consisting of an alkaline solution, a caustic soda, an acid, a hydrochloric acid, and a combination thereof.

2. A coating material as defined in claim 1, wherein the coating material is a material selected from the group consisting of a leather, a synthetic leather, a covering material, and a synthetic foil.

3. A coating material as defined in claim 1, wherein the coating material has a uniform material thickness provided by an additional material treatment after the chemical or the thermal treatment.

4. A coating material as defined in claim 1; and further comprising a covering material which is applied to the area portion after the chemical treatment or the thermal treatment.

5. A coating material as defined in claim 4, wherein said covering material is a hot adhesive.

6. A coating material as defined in claim 1, wherein the area portion is a portion subjected to the chemical treatment or the thermal treatment before or after finishing.

7. A coating material as defined in claim 1, wherein the coating material is composed of leather and has a material thickness of 0.6 mm-2.8 mm.

8. A coating material as defined in claim 1; and further comprising a cover sheet provided on a side of the coating composed of leather which faces the airbag, said cover sheet covering the treated area portion and being composed of a material selected from the group consisting of a foam material, a synthetic plastic material, and a varnish.

9. A coating material as defined in claim 1; and further comprising a cover sheet which is provided on a side of the coating which faces an airbag but leaves out the treated area portion.

10. A coating material as defined in claim 9, wherein said cover sheet is composed of laquer.

11. A method of producing a coating material for covering an airbag in an inner space of a motor vehicle, comprising forming an area portion adapted to face an airbag as a treated portion with a treatment selected from the group consisting of a chemical treatment, a thermal treatment and both; and using a fluid selected from the group consisting of an alkaline solution, a caustic soda, an acid, a hydrochloric acid, and a combination thereof.

12. A method as defined in claim 11, and further comprising using as the coating material is a material selected from the group consisting of a leather, a synthetic leather, a covering material, and a synthetic foil.

13. A method as defined in claim 11, and further comprising providing the coating material with a uniform material thickness provided by an additional material treatment after the chemical or the thermal treatment.

14. A method as defined in claim 11; and further comprising providing a covering material which is applied to the area portion after the chemical treatment or the thermal treatment.

15. A method as defined in claim 14; and further comprising using as said covering material is a hot adhesive.

16. A method as defined in claim 14; and further comprising subjecting the area portion to the chemical treatment or the thermal treatment before or after finishing.

17. A method as defined in claim 11; and further comprising making the coating material of and leather with a material thickness of 0.6 mm-2.8 mm.

18. A method as defined in claim 11; and further comprising providing a cover sheet on a side of the coating composed of leather which faces the airbag, covering with said cover sheet the treated area portion, making the cover sheet of a material selected from the group consisting of a foam material, a synthetic plastic material and a varnish.

19. A method as defined in claim 11; and further comprising providing a cover sheet on a side of the coating which faces an airbag but leaves out the treated area portion.

20. A method as defined in claim 19; and further comprising making said cover sheet of laquer.
